(19) United States
(12) Patent Application Publication
(10) Pub. No.: US 2026/0318222 A1
(43) Pub. Date: Oct. 15, 2026

(54) ADDITIVE MANUFACTURING AND HEAT TREATMENT OF DUAL-WALLED COMPONENTS

(71) Applicant: Rolls-Royce Corporation, Indianapolis, IN (US)

(72) Inventor: Timothy Paul Fuesting, Indianapolis, IN (US)

(21) Appl. No.: 19/178,232

(22) Filed: Apr. 14, 2025

(51) Int. Cl. F01D 25/12; F01D 5/18; F23R 3/00

(52) U.S. Cl. CPC F01D 25/12; F01D 5/147; F01D 5/18; F05D 2230/30; F05D 2260/201; F05D 2300/17

(57) ABSTRACT

A method of forming a dual-walled component of a gas turbine engine includes forming, via an additive manufacturing technique, the dual-walled component, and warm-working at least a portion of the dual-walled component, such as to increase a strength of the portion of the dual-walled component. For example, the dual-walled component may be a turbine blade that includes a root, a shank coupled to the root, a platform coupled to the root, and an airfoil coupled to the platform, and portions of the turbine blade subject to relatively high amounts of stress compared to the rest of the turbine blade, such as the root and the shank, may be warm-worked.

### TECHNICAL FIELD

The present disclosure relates to dual-walled components of a gas turbine engine.

### BACKGROUND

Hot section components of a gas turbine engine may be operated in high temperature environments that may approach or exceed the softening or melting points of the materials of the components. Such components may include various structures, such as turbine blades or vane airfoils, which may have one or more surfaces exposed to high temperature combustion or exhaust gases flowing across the surface of the component. Different techniques have been developed to assist with cooling of these components, such as application of a thermal barrier coating, construction of the component as a single or dual-walled structure, and passage of a cooling fluid, such as air, across or through a portion of the component to aid in cooling of the component.

### SUMMARY

The disclosure describes dual-walled components and methods of forming dual-walled components. A dual-walled component of a gas turbine engine may be fabricated using an additive manufacturing technique, such as laser powder bed fusion (LPBF) or directed energy deposition (DED), that forms a monolithic component without bond lines between a hot section portion and a cold section portion of the dual-walled component. Portions of the additively manufactured dual-walled component may be subject to relatively high amounts of stress, such as areas that typically include the roots and shanks of turbine blades. These high stress areas may be warm-worked to increase the strength and maintain the ductility of the component. As a result, additive manufacturing techniques may be used to manufacture components that may not otherwise have a requisite strength to meet the needs of the localized high stress areas.

In some examples, the disclosure describes a method of forming a dual-walled component of a gas turbine engine via an additive manufacturing technique that includes warm-working at least a portion of the dual-walled component, such as to increase a strength of the portion of the dual-walled component in the area of warm work. For example, the dual-walled component may be a turbine blade that includes a root, a shank coupled to the root, a platform coupled to the root, and an airfoil coupled to the platform, and portions of the turbine blade subject to relatively high amounts of stress compared to the rest of the turbine blade, such as the root and the shank, may be warm-worked.

In some examples, the disclosure describes a dual-walled component of a gas turbine engine that includes a cold section portion, a hot section portion, and a plurality of support structures positioned between the cold section portion and the hot section portion and forming a plurality of cooling channels. At least a portion of the cold section portion is warm-worked. For example, portions of the cold section portion that are warm-worked may have a higher strength than portions of the cold section portion that are not warm-worked.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a conceptual cross-sectional view of a wall of an example dual-walled component of a gas turbine engine.

FIG. 2A is a conceptual diagram of an exploded perspective view of an airfoil as part of a dual-walled component of a gas turbine engine.

FIG. 2B is a conceptual diagram of a perspective view of a turbine blade of a gas turbine engine that includes the airfoil of FIG. 2A.

FIG. 3 is a flow diagram illustrating an example method for forming a dual-walled component of a gas turbine engine.

### DETAILED DESCRIPTION

In general, the disclosure describes techniques for forming dual-walled components, such as dual-walled components for gas turbine engines. Components of a hot section of a gas turbine engine, such as a flame tube or combustor liner of a combustor or airfoils of a gas turbine engine, may be operated in high temperature gaseous environments that may approach or exceed the operational parameters for the respective components. To reduce or substantially eliminate the risk of melting the engine components, the component may include a dual-walled structure that interfaces with the gaseous environment. The dual-walled structure includes cooling channels that separate a hot section part (referred to herein as a “coversheet”) and a cold section part (referred to herein as a “spar”) of the dual-walled structure and permit flow of cooling air between the hot and cold section parts.

Often, the cooling channels may be formed using template-based methods, such as wax dies and/or ceramic cores, that create negative spaces during casting of the particular part. The templates used in these template-based methods may be complex and difficult to create, limiting their use to large-scale part manufacturing. The dual-walled structures may be formed by bonding multiple parts of a component (e.g., a coversheet, spar, and/or support structures of an airfoil) together. Such bonding creates a bond line between the different parts of the component, which mayless temperature and/or stress capability than the base material.

To avoid complex template-based manufacturing processes and bond lines, additive manufacturing techniques, such as LPBF or DED, may be used to form the dual-walled structure as a monolithic component that does not include bond lines between the different sections of the dual-walled component. However, the alloys deposited using additive manufacturing techniques may not have the requisite strength for certain areas on the component subject to dynamic forces, such as the root or shank on a turbine blade. For example, the microstructure of alloys deposited using additive manufacturing techniques includes grain boundaries, which are weaker points in the material and act as initiation sites for failure mechanisms such as creep, fatigue, and stress corrosion cracking. Portions of a turbine blade that attach an airfoil to a disk, such as the root and shank, may be subject to much higher forces/stress than other portions of the turbine blade, such as the airfoil, and this may result in cracking or other damage to the turbine blade in the localized areas of high stress. It is normal that such portions may be typically formed from alloys having a cast single crystal structure that cannot currently be deposited using additive manufacturing processes; these alloys lack grain boundaries and have significantly enhanced creep resistance and fatigue life at high temperatures. As a result, components fabricated solely via additive manufacturing may be limited to static components, such as turbine vanes, that are subject to lower localized stresses.

According to principles of the disclosure, a dual-walled component may be fabricated via additive manufacturing with sufficient strength for dynamic applications. The portions of the dual-walled component subject to relatively high dynamic forces, such as roots and shanks of turbine blades, may be warm-worked to increase the strength and fatigue capability of the component at those particular areas. In contrast to hot-working, which may be carried out above a full recrystallization temperature, warm-working is a metal-forming process carried out at below the full recrystallization temperature of the material. Warm-working may induce microstructural changes in the as-deposited material that increase the strength of the material while maintaining sufficient ductility in the material to resist cracking or failure. As a result, additive manufacturing techniques may be used to manufacture components that, but for the warm-worked portions, may not have a requisite strength.

In some examples, the dual-walled components may include turbine blades having a spar portion and a coversheet portion that are manufactured, alone or along with other structures, as a single component using an additive manufacturing process. The coversheet portion includes a complex cooling pattern of cooling channels using the additive manufacturing process. Portions of the component subject to high stress, such as a shank or root that couples to a rotor, may be subsequently warm-worked after fabrication of the component to impart additional strength in those particular portions of the component. This on-demand additive manufacturing of complex structures may enable fabrication of dual-walled components for a wide range of applications (e.g., design prototypes, rig test hardware/design refinement, and production hardware).

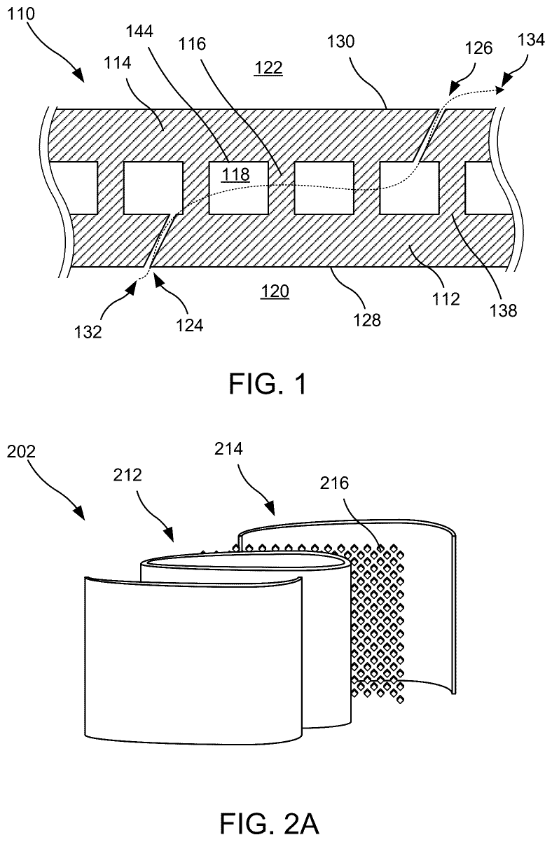

The methods described herein may be particularly useful for fabricating dual-walled components of gas turbine engines that include complex cooling circuits. FIG. 1 is a conceptual cross-sectional view of a wall of a portion of an example dual-walled component 110, such as a dual-walled component for a gas turbine engine. In some examples, dual-walled component 110 may be a part for the hot-section of a gas turbine engine (e.g., combustor, turbine, or exhaust sections) that receives or transfers cooling air as part of cooling system for the gas turbine engine. Dual-walled component 110 may include, for example, a component of a combustor such as a flame tube, combustion ring, combustor liner, an inner or outer casing, a combustor guide vane, or the like; a component of a turbine section such as a nozzle guide vane, a turbine disc, a turbine blade, a turbine vane, or the like; or another component associated with the hot section (e.g., a combustor or a high, low, or intermediate pressure turbine) of a gas turbine engine. Dual-walled component 110 may include portions that do not have a dual-walled structure, but that provide mechanical and/or functional support to the dual-walled structure. As mentioned above, and will be discussed further below, component 110 may be fabricated using additive manufacturing processes that enable relatively inexpensive and/or quick manufacture.

At least a portion of dual-walled component 110 includes a generally dual-walled structure, such as illustrated in FIG. 1, having two walls that are spaced to accommodate cooling air and/or maintain a thermal gradient across dual-walled component 110. Dual-walled component 110 includes a spar 112 as a cold section part and a coversheet 114 as a hot section part. Dual-walled component 110 may be configured to separate a cooling air plenum 120 adjacent to spar 112 from a heated gas environment 122 adjacent to coversheet 114, such that dual-walled component 110 acts as a physical divider between the two mediums. The terms “hot section part” and “cold section part” are used merely to orient which part is positioned adjacent to cooling air plenum 120 and which part is positioned adjacent to heated gas environment 122 and is not intended to limit the relative temperatures of the different environments or parts. For example, while spar 112 and cooling air plenum 120 may be described herein as “cold” sections compared to hot section part 114 and heated gas environment 122, the respective temperatures of spar 112 or cooling air plenum 120 may reach relatively high temperatures between about 1000 °F to about 2400 °F (e.g., about 760 °C to about 1300 °C) during routine operation, but may remain comparatively cool compared to the temperatures within heated gas environment 122.

Dual-walled component 110 includes a plurality of support structures 116 that separate a surface 138 of spar 112 from a surface 144 of coversheet 114. The plurality of support structures 116 define one or more cooling channels 118 between surface 138 of spar 112 and surface 144 of coversheet 114 amongst support structures 116. The presence of cooling channels 118 may create a zoned temperature gradient between the respective regions of cooling air plenum 120, cooling channels 118, and heated gas environment 122. Thus, dual-walled component 110 and the presence of cooling channels 118 may allow for more efficient cooling of the component compared to a comparable single-walled component.

To define cooling channels 118, the plurality of support structures 116 may take on any useful configuration, size, shape, or pattern. In some examples, the height of plurality of support structures 116 may be between about 0.2 mm and about 2 mm to define the height of cooling channels 118. In some examples, plurality of support structures 116 may include a plurality of columns, spires, pedestals, or the like which are used to separate spar 112 from coversheet 114 and creating a network of cooling channels 118 there between. In some examples, plurality of support structures 116 may also include one or more dams that act as zone dividers between adjacent cooling channels 118, thereby separating one cooling channel 118 from another between spar 112 from coversheet 114. In some examples, the pattern of cooling channels 118 may resemble a grid, wave, serpentine, swirl, or the like. In some examples, one or both of coversheet 114 and spar 112 may be formed to define a layer thickness (e.g., in the y-axis direction of FIG. 1) of about 0.014 inches to about 0.300 inches (e.g., about 0.36 mm to about 7.62 mm).

In addition to cooling channels 118, dual-walled component 110 may include other features configured to assist cooling. In some examples, spar 112 includes a plurality of impingement apertures 124 in surface 128 of spar 112 that extend between cooling air plenum 120 and the one or more cooling channels 118, thereby fluidically connecting plenum 120 to cooling channels 118. Similarly, in some examples, coversheet 114 may include a plurality of cooling apertures 126 in a surface 130 of coversheet 114 that extend between one or more cooling channels 118 and heated gas environment 122, thereby fluidically connecting environment 122 to cooling channels 118. In some examples, plurality of impingement apertures 124 and cooling apertures 126 (collectively, “apertures 124, 126”) may be introduced within respective hot or cold section parts at an angle to the surface of the part (e.g., an offset angle compared to the normal of a respective surface). A diameter of apertures 124, 126 may be less than about 0.01 inches to about 0.12 inches in diameter (e.g., about 0.25 millimeters (mm) to about 3 mm).

Rather than being separately manufactured and subsequently bonded, spar 112, coversheet 114, and the plurality of support structures 116 are integrally formed via an additive manufacturing process. For example, additive manufacturing processes like LPBF or DED may be capable of creating the complex internal features of cooling channels 118 without any bond lines that may result from forming spar 112 and coversheet 114 as separate components. These bond lines may be weak points in dual-walled component 110, particularly under high mechanical loads, thermal stresses, or vibration. If the bond interface is not perfect, repeated forces and thermal cycling may lead to delamination or failure under operating conditions. Residual stresses from the bonding process can accumulate along the bond line, making it susceptible to cracking or fatigue over time. Additionally, bond lines may experience differences in thermal expansion properties between the spar, the coversheet, and the bonding material; this mismatch can lead to thermal stresses, especially during rapid temperature changes, potentially compromising the integrity of the bond. By forming dual-walled component 110 via additive manufacturing, complex features of dual-walled component 110, such as the plurality of support structures 116, cooling channels 118, impingement apertures 124, and cooling apertures 126 may be quickly formed, thereby reducing a majority of machining and hole drilling operations for coversheet 114 and further reducing the cost.

As a result of the additive manufacturing process, each of spar 112, coversheet 114, and the plurality of support structures 116 include a polycrystalline metal alloy deposited in a layer-by-layer manner. Polycrystalline metal alloys include multiple crystalline grains with different orientations. While polycrystalline metal alloys may not have the enhanced mechanical properties of single crystal or directionally solidified metal alloys, the additive manufacturing process and subsequent heat treatments can be manipulated to create varying degrees of epitaxial growth. Epitaxial growth can provide enhanced properties in the direction of the growth. These properties can be enhanced further via warm working. Additive manufactured material and the associated post processing heat treatment can also produce polycrystalline materials with no epitaxial growth remaining, in this case warm working will also enhance the material mechanical properties. For example, the polycrystalline metal alloy may have a relatively high gamma prime content, such as greater than or equal to about 20 volume percent (vol. %). Additionally, such polycrystalline metal alloys may be warm-worked to increase strength. In this case, additive manufacturing techniques may be used to produce complex shapes of high temperature polycrystalline alloys. As such, dual-walled component 110 may be fabricated using additive manufacturing techniques that can be used to quickly design and fabricate a part without complex manufacturing techniques for forming cooling channels 118. The article produced can have mechanical properties enhanced in the monolithic regions of the article by warm working these areas thus enabling the component to meet all functional requirements.

Fabricating dual-walled component 110, including cooling channels 118, with printable high temperature alloys may provide adequate temperature capability for an outer surface of component 110, which is typically more oxidation limited than mechanical property limited. Spar 112 may provide the structural back bone of component 110, and has the mechanical property requirements that often require single crystal or directionally solidified metal alloys. As will be described further below, to provide these mechanical properties, portions of dual-walled component 110 that are subject to greater forces may be warm-worked to enhance the strength at those portions.

In some examples, component 110 may include an equiaxed metal alloy. Equiaxed metal alloys includes multiple small, randomly oriented crystalline grains having substantially equal dimensions in all directions, resulting in a relatively isotropic microstructure. Each crystal grain includes a multitude of individual crystals or grains that are arranged in a regular lattice structure. This polycrystalline structure of the equiaxed metal alloys may have a significant impact on its properties, such as strength, ductility, and toughness. Without being limited to any particular theory, equiaxed grains may be formed when a metal alloy solidifies from its molten state in a way that allows the crystalline grains to nucleate and grow with similar dimensions in all directions. This can occur under certain solidification conditions, such as when the metal alloy is cooled relatively uniformly or when it is subjected to mechanical agitation during solidification. Equiaxed alloys will have better diffusion and thus should be able to produce metallurgically better bond joints. High temperature (high gamma prime content) alloys typically can only be made by casting and any welding or additive processes normally will cause cracking. Improvements in additive processes and some alloy improvements now are capable of producing Ni-based alloys that have properties similar to high temperature equiaxed alloys that can only be made via casting.

Additive manufacturing techniques may be more capable of forming equiaxed metal alloys through control of localized parameters, such as heat input/power density, cooling rate, and solidification conditions, that influence the resulting microstructural features, such as grain size and morphology as well as resulting residual stress. For example, using lower power density can result in a uniform high cooling rate that will promote equiaxed grain growth in the deposited material. Some additive manufacturing techniques, such laser powder bed fusion (LPBF) and electron beam melting (EBM), inherently promote equiaxed grain structures due to the localized melting and rapid solidification involved.

In some examples, additive manufacturing of a polycrystalline metal alloy of component 110 may enable use of wider range of alloy compositions (as compared to conventional welding). The energy density/power input is more controlled with additive and thus the temperature and size of melt pool is more controlled as is residual stress. This level of control depends on factors such as the energy source used (e.g., laser or electron beam), and the process parameters, but allows for alloys deemed non-weldable to be successfully deposited.

During operation of dual-walled component 110, cooling air 132 from cooling air plenum 120 may pass through impingement apertures 124 entering and flowing through one or more cooling channels 118 prior to passing through cooling apertures 126 into heated gas environment 122. Cooling air 132 may assist in maintaining the temperature of dual-walled component 110 at a level lower than that of heated gas environment 122. For example, the temperature of the air within cooling air plenum 120 may be less than that of hot gas environment 122. Cooling air 132 may flow through impingement apertures 124 and impinge on the internal surface of coversheet 114, resulting in heat transfer from coversheet 114 to cooling air 132. Additional heat may be transferred from coversheet 114 and plurality of support structures 116 as cooling air 132 flows through one or more cooling channels 118. Further, cooling air 132 may exit cooling apertures 126 and enter heated gas environment 122, creating a thermally insulating film of relatively cool gas along surface 130 of dual-walled component 110 that allows surface 130 of dual-walled component 110 to remain at a temperature less than that of the bulk temperature of heated gas environment 122. In some examples, cooling air 132 may also at least partially mix with the gas of heated gas environment 122, thereby reducing the relative temperature of heated gas environment 122.

In some examples, cooling air 132 may act as a cooling reservoir that absorbs heat from portions of dual-walled component 110 as the air passes through one or more of cooling channels 118, impingement apertures 124, cooling apertures 126, or along one or more of the surfaces of dual-walled component 110, thereby dissipating the heat of dual-walled component 110 and allowing the relative temperature of dual-walled component 110 to be maintained at a temperature less than that of heated gas environment 122.

Cooling air plenum 120 and heated gas environment 122 may represent different flow paths, chambers, or regions within the gas turbine engine in which dual-walled component 110 is installed. For example, in some examples where dual-walled component 110 is a flame tube of a combustor of a gas turbine engine, heated gas environment 122 may include the combustion chamber within the flame tube and cooling air plenum may include the by-pass/cooling air that surrounds the exterior of the flame tube. In some examples in which dual-walled component 110 is a turbine blade or vane, heated gas environment 122 may include the environment external to and flowing past the turbine blade or vane while cooling air plenum 120 may include one or more interior chambers within the turbine blade or vane representing part of the integral cooling system of the gas turbine engine. In such examples, spar 112 may represent the spar of an airfoil (e.g., blade or vane) and coversheet 114 may represent one or more of the coversheets being bonded to the spar.

In some examples, cooling air 132 may be supplied to dual-walled component 110 (e.g., via cooling air plenum 120) at a pressure greater than the gas path pressure within heated gas environment 122. The pressure differential between cooling air plenum 120 and heated gas environment 122 may force cooling air 132 through one or more of the flow paths established by cooling channels 118, impingement apertures 124, and cooling apertures 126 (collectively flow paths 134).

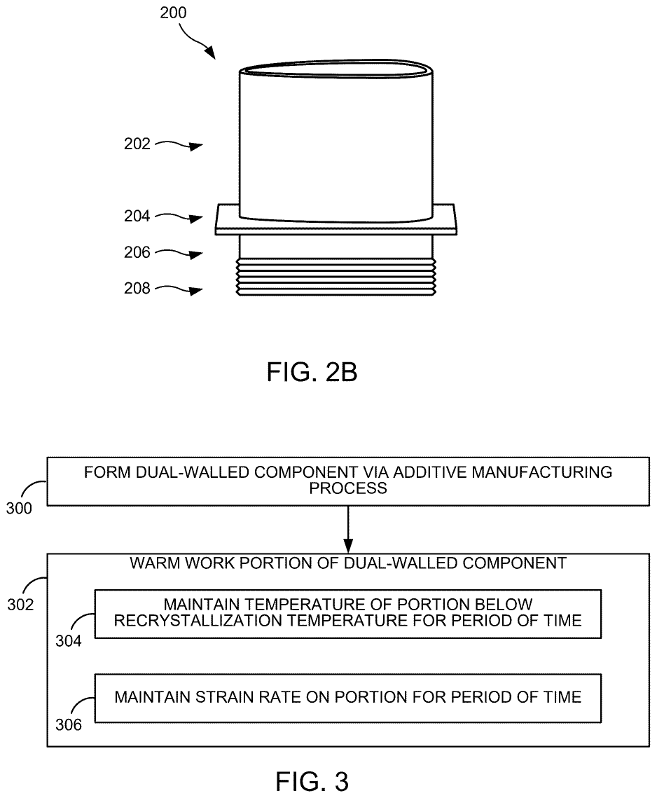

FIG. 2A is a conceptual diagram of an exploded perspective view of an airfoil 202 as part of a dual-walled component of a gas turbine engine, such as dual-walled component 110 of FIG. 1. Airfoil 202 includes a spar 212 as a cold section part, a coversheet 214 as a hot section part, and a plurality of support structures 216 separating spar 212 and coversheet 214. Spar 212 and coversheet 214 may work together to provide structural strength, aerodynamic efficiency, and durability to airfoil 202 to withstand the extreme conditions of gas turbine engine operation. Unless otherwise specified, spar 212, coversheet 214, and the plurality of support structures 216 may be similar to spar 112, coversheet 114, and the plurality of support structures 116 of dual-walled component 110 of FIG. 1. While shown in isolation, airfoil 202 may be coupled to, and formed monolithically with, other portions of a dual-walled component, such as will be described in FIG. 2B below.

In airfoil 202, spar 212 may be the primary load-bearing structure, and may be configured to withstand centrifugal forces generated by rotation of airfoil 202 and/or aerodynamic forces acting on airfoil 202 during operation. Spar 212 provides structural integrity to airfoil 202, maintaining its shape and resisting deformation under high centrifugal loads and aerodynamic forces. Spar 212 may also serve as a heat sink to dissipate heat generated by combustion or friction. In contrast, coversheet 214 defines an outer surface of airfoil 202. Coversheet 214 may maintain an aerodynamic profile of airfoil 202 to ensure smooth airflow over the outer surface. Coversheet 214 may be compatible with high temperatures and harsh operating conditions experienced by airfoil 202 in the gas turbine engine environment. Coversheet 214 may also include coatings, such as abradable coatings, thermal barrier coatings, and/or environmental barrier coatings to maintain a low clearance and/or protect the underlying structure from thermal and/or environmental degradation.

In some examples, dual-walled components formed through additive manufacturing and selective warm-working may include components that have complex features, and are subject to high forces that require high strength materials. For example, such dual-walled component may include a turbine blade may have a dual-walled airfoil, such as airfoil 202. FIG. 2B is a conceptual diagram of a perspective view of a turbine blade 200 of a gas turbine engine that includes airfoil 202 of FIG. 2A. Turbine blade 200 includes airfoil 202, a platform 204 coupled to airfoil 202, the area below the platform where load transfer from the airfoil/platform to the root attachment is the shank 206 coupled to airfoil 202, and the area of machined features for mechanical interlocking and load transfer to the disk is called the root 208 and usually starts with a shape transition out of the bottom of the shank 206.

Airfoil 202 and platform 204 are configured to interface with a high temperature, high velocity gas flow. As explained in FIG. 2A above, airfoil 202 is configured to interact with the gas flow to convert energy from the gas into mechanical work by generating lift and torque. Airfoil 202 is contoured for aerodynamic performance and is cooled internally, such as via cooling channels formed by the plurality of support structures, to withstand the extreme temperatures. Platform 204 is positioned at a base of airfoil 202 and defines an inner boundary of the gas path. Platform 204 guides the hot gases and prevents leakage between adjacent blades to maintain aerodynamic efficiency, and protects the lower parts of turbine blade 200 from exposure to hot gases.

Shank 206 and root 208 are configured to support airfoil 202 and platform 204, and do not contact the gas flow. Shank 206 and root 208 transfer mechanical loads from turbine blade 200 to a rotor shaft. Shank 206 is configured to connect turbine blade 200 to the root which is normally inserted into a turbine disk or rotor. Shank 206 may include cooling features to manage heat removed from airfoil 202 and platform 204. Root 208 is an innermost part of turbine blade 200 that directly attaches to the turbine disk or rotor. Root may be shaped to securely attach turbine blade 200 to the turbine disk, permit thermal expansion, and reduce stress concentrations.

Different portions of turbine blade 200 may be subject to different stresses. For example, gas flow facing portions of turbine blade 200, such as a coversheet of airfoil 202, may be subject to aerodynamic forces (e.g., gas flow that exerts lift and drag on the airfoil that generate torque) and centrifugal forces (e.g., high rotational speeds that generate tensile forces). In contrast, load bearing portions of turbine blade 200, such as a spar of airfoil 202, shank 206, and root 208 may be subject to substantially greater centrifugal forces (e.g., transmission of tensile loads from airfoil 202 to a turbine disk). While untreated metal alloys that result from additive manufacturing may have mechanical properties that are sufficient to maintain integrity of flow-facing portions of turbine blade 200, such untreated metal alloys may not have mechanical properties that are sufficient for maintaining integrity of the load-bearing portions of turbine blade 200.

To increase mechanical properties of these load-bearing portions, at least a portion of the load-bearing portions may be warm-worked; in the example turbine blade 200 of FIG. 2B, at least shank 206 and root 208 are warm-worked. Warm-working is a metal-forming process carried out within a temperature range that is above room temperature (e.g., 25 °C) but below the full recrystallization temperature of the material. This temperature range may be between about 0.3 and about 0.5 of a melting point temperature of the material. The material may be subjected to forces having strain rates that are sufficiently high to impart strain through the bulk of the metal and yet low enough to reduce a likelihood of cracking. Within this temperature and force range, the material may retain some of its work-hardening characteristics, and various recovery processes (e.g., dislocation rearrangement and reduction in internal stress) may occur, resulting in adequate ductility. Likewise, the deformation of individual grains through slip systems will be evident as a developed aspect ratio of the grain. While partial recrystallization may begin during warm-working, full recrystallization may not occur until a recrystallization temperature closer to 0.5-0.6 of the melting point temperature of the material. Full recrystallization by definition would eliminate or dramatically reduce the benefit from warm working.

Warm-working may result in various microstructural changes in the material that increase strength, such as slip re-orientation of grains/aspect ratio development increased dislocation density, and in some instances, enhancing precipitation strengthening of a gamma prime phase (dislocation interaction) For example, elevated temperatures of warm-working may facilitate dynamic recrystallization, creating smaller grains. Warm-working may increase dislocation density, contributing to strength via work hardening. For some alloys, warm-working temperature aligns with conditions for forming fine precipitates, which impede dislocation motion. All of the aforementioned phenomena can improve the mechanical properties in the area being warm worked.

Rapid solidification results in less segregation and a refined dendritic/grain structure that enhances strength and ductility thus reducing the tendency for cracking. Warm-working may help relax residual stresses, reducing the risk of cracking and distortion while improving dimensional stability.

In some examples, the polycrystalline metal alloy comprises a Ni-based alloy or a Co-based alloy. These alloys may have warm-working temperatures between about 750 °C and about 1000 °C. Nickel- and cobalt-based superalloys are designed for excellent thermal stability and resistance to grain coarsening at high temperatures. Nickel-based and cobalt-based alloys may form metastable phases or γ′/γ″ precipitates during additive manufacturing and cooling. These materials retain their properties at warm-working temperatures, allowing deformation and strengthening without excessive softening or grain growth. As a result of warm-working, nickel-based and cobalt-based alloys may have increased strength due to higher dislocation density, slip system rotation and interaction of dislocations with strengthening phases (e.g., γ′ or γ″ in nickel-based alloys and carbides in cobalt-based alloys). These phenomena result in improved mechanical properties including strength and fatigue resistance.

FIG. 3 is a flow diagram illustrating an example method for forming a dual-walled component of a gas turbine engine. FIG. 3 will be described with respect to dual-walled component 110 of FIG. 1, airfoil 202 of FIG. 2A, and turbine blade 200 of FIG. 2B; however, the technique of FIG. 3 may be used to form other dual-walled components.

The example technique of FIG. 3 includes forming, via an additive manufacturing process, dual-walled component 110 (300), such that spar 112, coversheet 114, and the plurality of support structures 116 include a polycrystalline metal alloy and form a plurality of cooling channels 118. A computer-aided model of component 110 may be developed, and may be further processed into cross-sectional layers to determine a tool path. Such computer-aided model may include details of the cooling circuit of component 110, including the plurality of cooling channels 118 and/or the plurality of cooling apertures 126. The polycrystalline metal alloy may be selected to include various mechanical and chemical properties suitable for an outer surface of component 110, such as corrosion resistance and mechanical strength. For an LPBF manufacturing process, the polycrystalline metal alloy may be delivered to a build platform as a powder and selectively heated to cause powder to fuse together or sinter, forming a solidified layer. The fusion process may involve heating the powder to just below a melting point, allowing the powder to bond together while maintaining the overall shape of the section of spar 112 and coversheet 114. After each layer is selectively fused, the previously fused layer undergoes cooling and solidification, which helps to stabilize the structure and prevent warping or distortion. In some examples, such as for equiaxed metal alloys, the heating and cooling may be carefully controlled to ensure relatively uniform grains. The process of selectively fusing is repeated layer by layer until the entire component 110 is fabricated. In some examples, temporary support external support structures may be used to support component 110, such as coversheet 114, and help prevent deformation or collapse of component 110 during printing.

The method of FIG. 3 includes warm-working at least a portion of dual-walled component 110 (302), such as a portion that will be subject to a relatively high degree of strain compared to other portions of component 110. In the example of FIG. 2B, shank 206 and root 208 may be warm-worked. A variety of warm-working processes may be used depending on a shape of the portion of dual-walled component 110 including, but not limited to, forging, rolling, piercing, and the like. In the example of FIG. 2B, shank 206 and root 208 may be warm-working via forging by using one or more dies shaped to a form of the portion of shank 206 and root 208.

The portion of dual-walled component that may be warm-worked may include a portion of dual-walled component 110 that may be subject to relatively high stresses during operation compared to other portions of dual-walled component 110, and may not be a portion of dual-walled component 110 that includes a dual-wall (e.g., a hot section and a cold section). For example, the portion of dual-walled component 110 that may be warm-worked may be a portion of that is integral with a portion of the dual-walled structure, but may not include the dual-walled structure itself. In the example of FIG. 2B, the portion of turbine blade 200 that is warm-worked may include shank 206 and root 208 that do not include a cooling circuit (or include a less intricate cooling circuit for supplying cooling air to airfoil 202), rather than airfoil 202 that includes the cooling circuit.

Warm-working conditions for metal alloys deposited using additive manufacturing, such as nickel-based and cobalt-based alloys, may involve a balance between temperature, strain rate, and duration to achieve the desired material properties while avoiding excessive grain growth, oxidation, or cracking. In some examples, warm-working includes maintaining a temperature of the portion of dual-walled component 110 below a recrystallization temperature for a period of time (304). Warm working temperatures may be set to encourage dynamic recovery or partial recrystallization, preventing coarse grains while retaining strength. For example, for a nickel-based alloy, warm-working may include maintaining a temperature between about 650 °C and about 950 °C, while for a cobalt-based alloy, warm-working may include maintaining a temperature between about 600 °C and about 950 °C. These temperatures may be below a solution-treatment temperature and avoid full recrystallization. Warm working typically involves continuous or repeated deformation steps. Prolonged processing times may require maintaining temperatures either through adiabatic heating or re-heating within the controlled range to avoid work hardening.

In some examples, warm-working includes maintaining a strain rate of the portion of dual-walled component 110 within a strain rate for a period of time (306). For example, for nickel-based and cobalt-based alloys, moderate strain rates of 0.001 to 1 s⁻¹ may be used. Strain rates are dependent on the alloy, temperature, and desired results.

Throughout warm-working, component 110 may be protected from adverse effects of heat treatment. For example, nickel and cobalt alloys may be susceptible to oxidation at high temperatures, such that warm working may be performed in a protective atmosphere (e.g., argon, vacuum) or with a surface coating. Component 110 may also be subject to additional heat treatments. For example, nickel and cobalt alloys tend to work harden significantly, such that intermittent annealing may be performed during extended warm working processes, such as forging.

After warm-working, the portion of turbine blade 200 warm-worked, such as shank 206 or root 208, may have increased strength compared to portions of turbine blade 200, such as airfoil 202, that have not been warm-worked. For example, a portion of turbine blade 200 that is warm-worked may have a tensile strength that is at least 5 percent (%) higher and/or a yield strength that is at least 10% higher than a portion of turbine blade 200 that is not warm-worked. As another example, a portion of turbine blade 200 that is warm-worked may have a ductility that is at not more than 30% lower than a portion of turbine blade 200 that is not warm-worked.

Example 1: A method of forming a dual-walled component of a gas turbine engine includes forming, via an additive manufacturing technique, the dual-walled component, wherein the dual-walled component comprises: a cold section portion; a hot section portion; and a plurality of support structures positioned between the cold section portion and the hot section portion and forming a plurality of cooling channels; and warm-working at least a portion of the dual-walled component.

Example 2: The method of example 1, wherein warm-working comprises: maintaining a temperature of the portion of the dual-walled component below a recrystallization temperature for a period of time; and working the portion of the component during the period of time.

Example 3: The method of example 2, wherein the temperature is between about 650 degrees Celsius (°C) and about 1000 °C.

Example 4: The method of any of examples 1 through 3, wherein warm-working comprises maintaining a strain rate on the portion of the dual-walled component between about 0.001 to about 1 per second (s⁻¹).

Example 5: The method of any of examples 1 through 4, wherein warm-working comprises forging.

Example 6: The method of any of examples 1 through 5, wherein the dual-walled component comprises a polycrystalline metal alloy comprising a Ni-based alloy or a Co-based alloy.

Example 7: The method of example 6, wherein the polycrystalline metal alloy comprises the Ni-based alloy having a gamma prime content of at least about 20 weight percent (wt. %).

Example 8: The method of any of examples 1 through 7, wherein the dual-walled component comprises at least one of a flame tube, a combustion ring, a combustor casing, a combustor guide vane, a turbine vane, a turbine disc, or a turbine blade.

Example 9: The method of any of examples 1 through 8, wherein the dual-walled component includes an airfoil, wherein the cold section portion comprises a spar of the airfoil, and wherein the hot section portion comprises a coversheet of the airfoil.

Example 10: The method of example 9, wherein the dual-walled component comprises a turbine blade comprising a root, a shank coupled to the root, and the airfoil coupled to the shank, and wherein at least one of the root or the shank is warm-worked.

Example 11: The method of any of examples 1 through 10, wherein the hot section portion comprises a plurality of cooling apertures fluidically connecting a heated gas environment to the plurality of cooling channels.

Example 12: The method of any of examples 1 through 11, wherein the cold section portion comprises a plurality of impingement apertures fluidically connecting a cooling air plenum to the plurality of cooling channels.

Example 13: A dual-walled component of a gas turbine engine includes a cold section portion; a hot section portion; and a plurality of support structures positioned between the cold section portion and the hot section portion and forming a plurality of cooling channels, wherein at least a portion of the dual-walled component is warm-worked.

Example 14: The dual-walled component of example 13, wherein the dual-walled component comprises a polycrystalline metal alloy comprising a Ni-based alloy or a Co-based alloy.

Example 15: The dual-walled component of example 14, wherein the polycrystalline metal alloy comprises the Ni-based alloy having a gamma prime content of at least about 20 weight percent (wt. %).

Example 16: The dual-walled component of any of examples 13 through 15, wherein the dual-walled component comprises at least one of a flame tube, a combustion ring, a combustor casing, a combustor guide vane, a turbine vane, a turbine disc, or a turbine blade.

Example 17: The dual-walled component of any of examples 13 through 16, wherein the dual-walled component includes an airfoil, wherein the cold section portion comprises a spar of the airfoil, and wherein the hot section portion comprises a coversheet of the airfoil.

Example 18: The dual-walled component of example 17, wherein the dual-walled component comprises a turbine blade comprising a root, a shank coupled to the root, and the airfoil coupled to the shank, and wherein at least one of the root or the shank is warm-worked.

Example 19: The dual-walled component of any of examples 13 through 18, wherein the hot section portion comprises a plurality of cooling apertures fluidically connecting a heated gas environment to the plurality of cooling channels.

Example 20: The dual-walled component of any of examples 13 through 19, wherein the cold section portion comprises a plurality of impingement apertures fluidically connecting a cooling air plenum to the plurality of cooling channels.

Various examples have been described. These and other examples are within the scope of the following claims.

What is claimed is:

1. A method of forming a dual-walled component of a gas turbine engine, comprising:
forming, via an additive manufacturing technique, the dual-walled component, wherein the dual-walled component comprises:
a cold section portion;
a hot section portion; and
a plurality of support structures positioned between the cold section portion and the hot section portion and forming a plurality of cooling channels; and
warm-working at least a portion of the dual-walled component.

2. The method of claim 1, wherein warm-working comprises:
maintaining a temperature of the portion of the dual-walled component below a recrystallization temperature for a period of time; and
working the portion of the component during the period of time.

3. The method of claim 2, wherein the temperature is between about 650 degrees Celsius (°C) and about 1000 °C.

4. The method of claim 1, wherein warm-working comprises maintaining a strain rate on the portion of the dual-walled component between about 0.001 to about 1 per second (s⁻¹).

5. The method of claim 1, wherein warm-working comprises forging.

6. The method of claim 1, wherein the dual-walled component comprises a polycrystalline metal alloy comprising a Ni-based alloy or a Co-based alloy.

7. The method of claim 6, wherein the polycrystalline metal alloy comprises the Ni-based alloy having a gamma prime content of at least about 20 weight percent (wt. %).

8. The method of claim 1, wherein the dual-walled component comprises at least one of a flame tube, a combustion ring, a combustor casing, a combustor guide vane, a turbine vane, a turbine disc, or a turbine blade.

9. The method of claim 1,
wherein the dual-walled component includes an airfoil,
wherein the cold section portion comprises a spar of the airfoil, and
wherein the hot section portion comprises a coversheet of the airfoil.

10. The method of claim 9,
wherein the dual-walled component comprises a turbine blade comprising a root, a shank coupled to the root, and the airfoil coupled to the shank, and
wherein at least one of the root or the shank is warm-worked.

11. The method of claim 1, wherein the hot section portion comprises a plurality of cooling apertures fluidically connecting a heated gas environment to the plurality of cooling channels.

12. The method of claim 1, wherein the cold section portion comprises a plurality of impingement apertures fluidically connecting a cooling air plenum to the plurality of cooling channels.

13. A dual-walled component of a gas turbine engine, comprising:
a cold section portion;
a hot section portion; and
a plurality of support structures positioned between the cold section portion and the hot section portion and forming a plurality of cooling channels,
wherein at least a portion of the dual-walled component is warm-worked.

14. The dual-walled component of claim 13, wherein the dual-walled component comprises a polycrystalline metal alloy comprising a Ni-based alloy or a Co-based alloy.

15. The dual-walled component of claim 14, wherein the polycrystalline metal alloy comprises the Ni-based alloy having a gamma prime content of at least about 20 weight percent (wt. %).

16. The dual-walled component of claim 13, wherein the dual-walled component comprises at least one of a flame tube, a combustion ring, a combustor casing, a combustor guide vane, a turbine vane, a turbine disc, or a turbine blade.

17. The dual-walled component of claim 13,
wherein the dual-walled component includes an airfoil,
wherein the cold section portion comprises a spar of the airfoil, and
wherein the hot section portion comprises a coversheet of the airfoil.

18. The dual-walled component of claim 17,
wherein the dual-walled component comprises a turbine blade comprising a root, a shank coupled to the root, and the airfoil coupled to the shank, and
wherein at least one of the root or the shank is warm-worked.

19. The dual-walled component of claim 13, wherein the hot section portion comprises a plurality of cooling apertures fluidically connecting a heated gas environment to the plurality of cooling channels.

20. The dual-walled component of claim 13, wherein the cold section portion comprises a plurality of impingement apertures fluidically connecting a cooling air plenum to the plurality of cooling channels.
